(19) United States
(12) Patent Application Publication
(10) Pub. No.: US 2019/0245262 A1
(43) Pub. Date: Aug. 8, 2019

(54) ANTENNA SYSTEM AND MOBILE TERMINAL

(71) Applicant: AAC Technologies Pte. Ltd., Singapore city (SG)

(72) Inventors: Xiaoyue Xia, Shenzhen (CN); Chao Wang, Shenzhen (CN)

(21) Appl. No.: 16/057,960

(22) Filed: Aug. 8, 2018

(30) Foreign Application Priority Data
Dec. 13, 2017 (CN) 201711326170.9

(51) Int. Cl. H01Q 1/24; H01Q 21/22; H04M 1/02; H01Q 3/38

(52) U.S. Cl. CPC H01Q 1/243; H01Q 21/22; H01Q 3/38; H04M 1/0266; H04M 1/0277

(57) ABSTRACT

The present disclosure discloses an antenna system and a mobile terminal. The antenna system is applied to the mobile terminal and includes a first feeding point, a first millimeter-wave array antenna electrically connected to the first feeding point, a second feeding point, a second millimeter-wave array antenna electrically connected to the second feeding point, a third feeding point, a third millimeter-wave array antenna electrically connected to the third feeding point, a fourth feeding point, and a fourth millimeter-wave array antenna electrically connected to the fourth feeding point, which are all disposed on the circuit board; beams of the first millimeter-wave array antenna cover a space of Z>0; beams of the second millimeter-wave array antenna cover a space of Z<0; beams of the third millimeter-wave array antenna cover a space of Y>0; and beams of the fourth millimeter-wave array antenna cover a space of Y<0.

### CROSS-REFERENCE TO RELATED APPLICATIONS

The present application claims priority to Chinese Patent Application No. 201711326170.9, filed on Dec. 13, 2017, the content of which is incorporated herein by reference in its entirety.

### TECHNICAL FIELD

The embodiments of the present disclosure relate to the field of communications, and in particular, to an antenna system and a mobile terminal.

### BACKGROUND

With constant development of the communication technology, the Fifth-Generation mobile communication technology (5G) can be seen behind cool hot technologies such as a virtual reality technology, an unmanned aerial vehicle technology, and an autopilot technology. The fifth-generation mobile communication technology is an extension of 4G and is currently under study. The theoretical downlink speed of the 5G network is 10 Gb/s (equivalent to a download speed of 1.25 GB/s). In terms of capacity, the mobile data traffic per unit area of 5G is increased by 1,000 times than 4G. In terms of transmission rate, the typical user data rate is increased by 10 to 100 times and the peak transmission rate can reach 10 Gbps (which is 100 Mbps in 4G). It can be seen therefrom that 5G will fully surpass 4G in all aspects to achieve the true fusion network.

The International Telecommunication Union (ITU) defined the main application scenarios of 5G at the ITU-RWPSD 22nd meeting on June 2015. The ITU defines three main application scenarios: enhanced mobile broadband, large-scale machine communications, and highly reliable low-latency communications. These three application scenarios correspond to different key indicators. Under the enhanced mobile bandwidth scenario, the user peak velocity is 20 Gbps, and the minimum user experience rate is 100 Mbps. Many key technologies, such as a millimeter wave technology and a beam-forming technology, are adopted in 5G communication to achieve the above indicators. Rich bandwidth resources of a millimeter wave band provide guarantees for high-speed transmission rates. However, due to the severe spatial loss of electromagnetic waves in this band, phased array architecture is needed for a wireless communication system using the millimeter wave band. By means of a phase shifter, the phase of each array element is distributed according to a certain rule, thereby forming a high-gain beam. In addition, by the change in phase shift, the beam is scanned within a certain spatial range.

In the beam-forming technology of 5G communication, a base station side has multiple antennas and may automatically adjust phase positions of transmitted signals of the antennas to form a superposition of electromagnetic waves at a terminal receiving point, thereby improving the received signal strength. The inventor has found that the related art has at least the following problems: a 5G terminal also needs to use a millimeter-wave phased array antenna and has a phased array of N*N dot matrix. However, this phased array takes up a large space of a mobile phone and is not easy to deploy, and setting of its scanning angle is complicated. Because the scanning coverage of a single phased array antenna is generally smaller than a hemisphere, if the 5G terminal adopts the single phased array antenna, there may be a problem that a smart terminal is unstable in signal receiving.

### BRIEF DESCRIPTION OF DRAWINGS

One or more embodiments are illustrated by way of examples with reference to the figures in the drawings corresponding to the respective embodiments. These exemplary illustrations are not intended to limit the embodiments. Throughout the drawings, the same reference numbers represent similar elements. Unless otherwise specified, the figures in the drawings are not to scale.

FIG. 1 is an exploded schematic view of a mobile terminal to which an antenna system provided according to a first embodiment of the present disclosure is applied;

FIG. 2A is a schematic view of the front face of the mobile terminal provided by the first embodiment, and FIG. 2B is a schematic view of the rear face of the mobile terminal provided by the first embodiment;

FIG. 3A is a schematic view of the main beam of the first millimeter-wave array antenna pointing to a space of Z>0; FIG. 3B is a schematic view of the main beam of the second millimeter-wave array antenna pointing to a space of Z<0; FIG. 3C is a schematic view of the main beam of the third millimeter-wave array antenna pointing to a space of Y>0;

FIG. 3D is a schematic view of the main beam of the fourth millimeter-wave array antenna pointing to a space of Y<0;

FIG. 4 is a specific structural schematic view of the antenna system provided according to the first embodiment of the present disclosure when it faces a positive direction of a Z axis;

FIG. 5 is a specific structural schematic view of the antenna system provided according to the first embodiment of the present disclosure when it faces away from the positive direction of the Z axis;

FIG. 6A is a pattern of a fourth millimeter-wave array antenna on an H plane when various fourth antenna units are fed at a constant amplitude and a same phase in the antenna system provided according to the first embodiment of the present disclosure;

FIG. 6B is a pattern of the fourth millimeter-wave array antenna on an E plane when various fourth antenna units are fed at a constant amplitude and a same phase in the antenna system provided according to the first embodiment of the present disclosure;

FIG. 7 is a radiation coverage efficiency view when a first millimeter-wave array antenna and a second millimeter-wave array antenna in the antenna system provided according to the first embodiment of the present disclosure operate;

FIG. 8 is a radiation coverage efficiency view when a third millimeter-wave array antenna and a fourth millimeter-wave array antenna in the antenna system provided according to the first embodiment of the present disclosure operate;

FIG. 9 is a radiation coverage efficiency view when the four millimeter-wave array antennas in the antenna system provided according to the first embodiment of the present disclosure operate;

FIG. 10 is a beam management principle view in the antenna system provided according to the first embodiment of the present disclosure;

FIG. 11 is a structural schematic view of a mobile terminal provided according to a second embodiment of the present disclosure; and

FIG. 12 is an architecture schematic view of an antenna system in the mobile terminal provided according to the second embodiment of the present disclosure.

### DESCRIPTION OF EMBODIMENTS

In order to make the objectives, technical solutions, and advantages of the present disclosure more clear, various embodiments of the present disclosure are described in detail below with reference to the accompanying drawings. It may be understood by an ordinary person skilled in the art that many technical details are set forth in various embodiments of the present disclosure to give the reader a fuller understanding of the present disclosure. However, even though these technical details, and various changes and modifications based on the following embodiments are not set forth, the claimed technical solution of the present disclosure may be implemented.

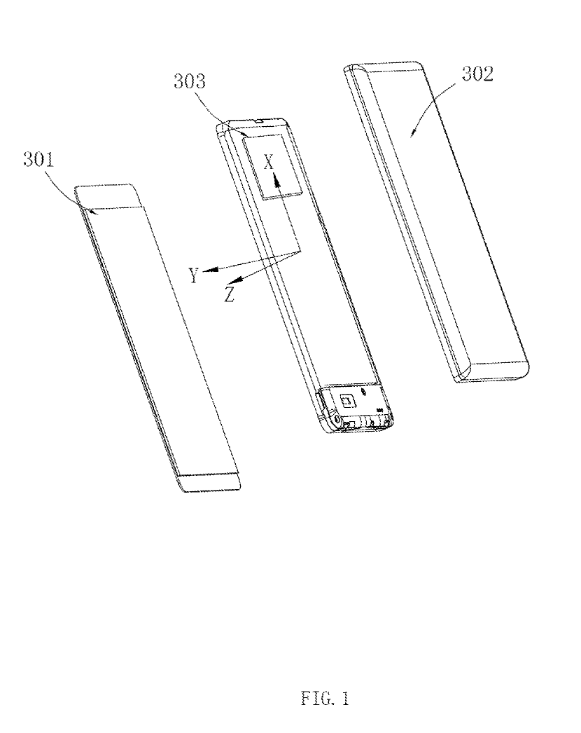

A first embodiment of the present disclosure relates to an antenna system 10 that is applied to a mobile terminal. The mobile terminal is provided with a screen 301, a back shell 302 opposite to the screen 301 and a circuit board 303 sandwiched between the screen 301 and the back shell 302, as shown in FIG. 1 which is an exploded view. The mobile terminal may be a smart phone, a smart watch or the like. In this embodiment, the mobile terminal is illustrated as the smart phone for example.

The antenna system includes a first feeding point 101, a first millimeter-wave array antenna 102 electrically connected to the first feeding point 101, a second feeding point 103, a second millimeter-wave array antenna 104 electrically connected to the second feeding point 103, a third feeding point 105, a third millimeter-wave array antenna 106 electrically connected to the third feeding point 105, a fourth feeding point 107, and a fourth millimeter-wave array antenna 108 electrically connected to the fourth feeding point 107, which are all disposed on the circuit board 303.

For ease of description, the mobile terminal is placed in a three-dimensional coordinate system that takes the center of the mobile terminal as an origin. An X axis of the three-dimensional coordinate system extends in a major-axis direction of the mobile terminal. A Y axis of the three-dimensional coordinate system extends in a minor-axis direction of the mobile terminal. A Z axis of the three-dimensional coordinate system extends in a thickness direction of the mobile terminal. A positive axis of the X axis points to the top of the mobile terminal. A positive axis of the Z axis points to the screen.

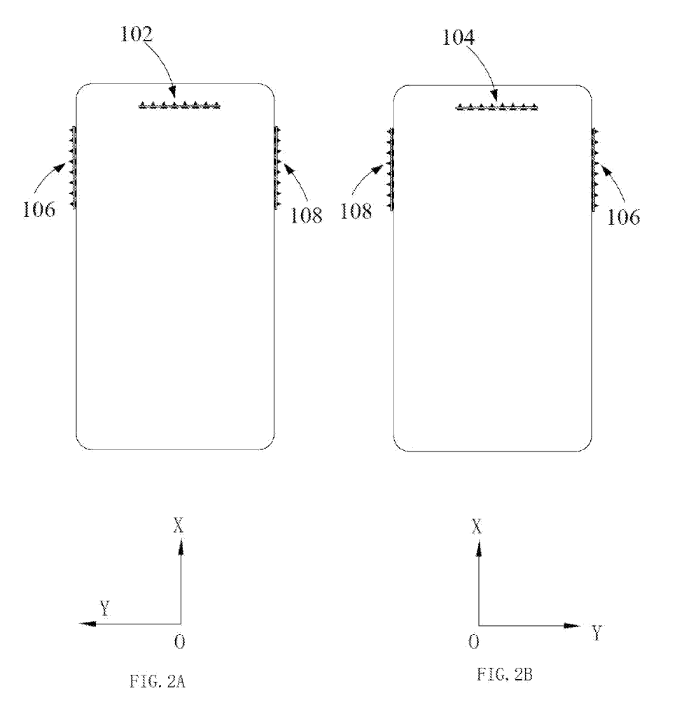

FIG. 2A shows a front face of a mobile terminal provided by the first embodiment, and FIG. 2B shows a rear face of the mobile terminal provided by the first embodiment. The four millimeter-wave array antennas, namely, the first millimeter-wave array antenna 102, the second millimeter-wave array antenna 104, the third millimeter-wave array antenna 106 and the fourth millimeter-wave array antenna 108, are disposed in the antenna system involved in this embodiment in total.

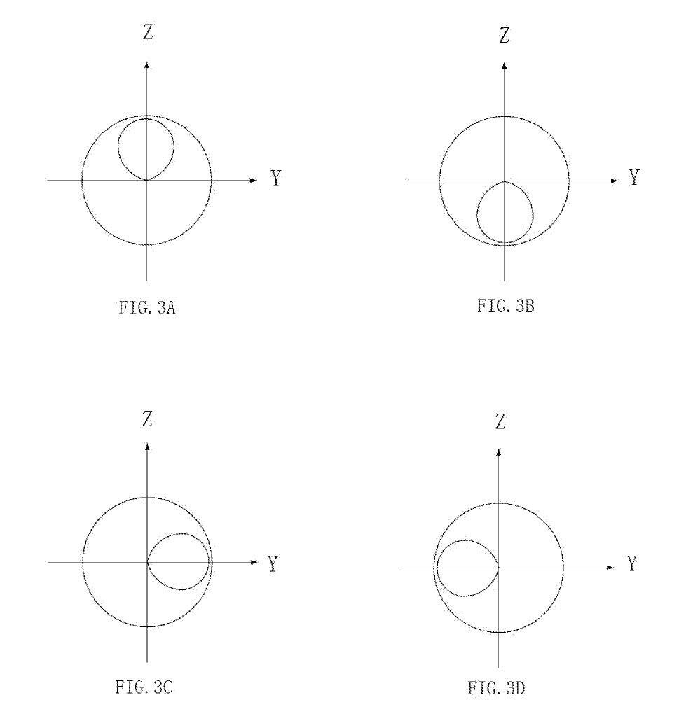

As shown in FIG. 3A, a main beam of the first millimeter-wave array antenna points to a space of Z>0. As shown in FIG. 3B, a main beam of the second millimeter-wave array antenna points to a space of Z<0. As shown in FIG. 3C, a main beam of the third millimeter-wave array antenna points to a space of Y>0. As shown in FIG. 3D, a main beam of the fourth millimeter-wave array antenna points to a space of Y<0.

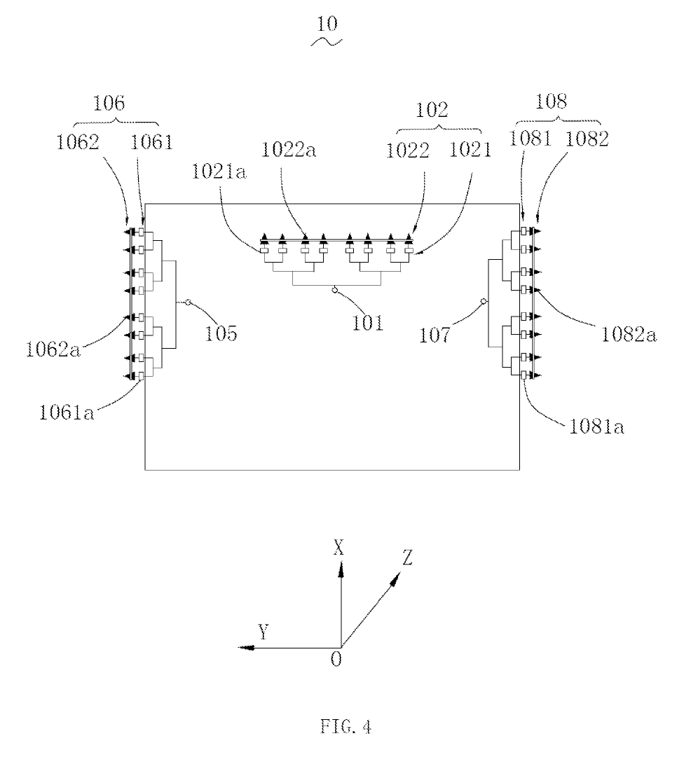

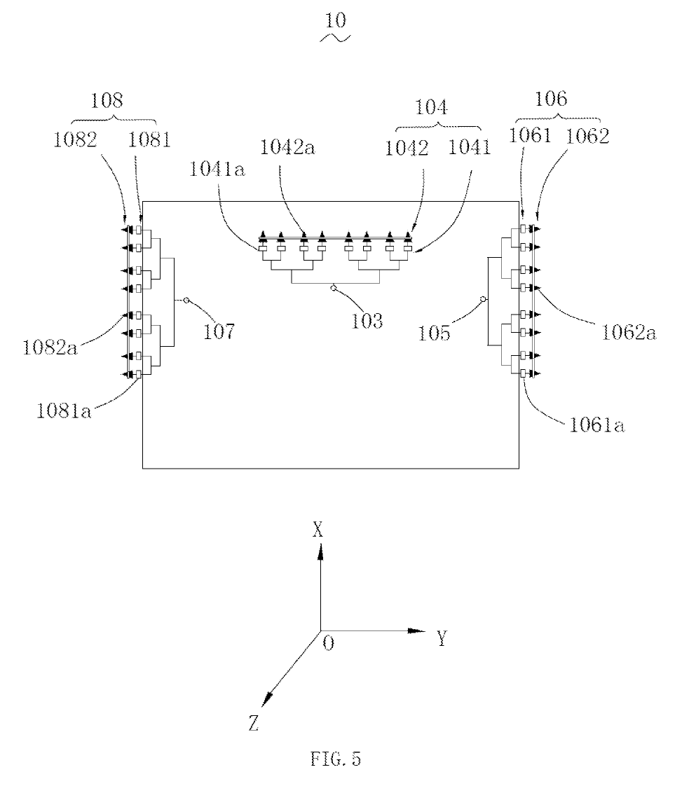

In one embodiment, the first feeding point 101, the second feeding point 103, the third feeding point 105 and the fourth feeding point 107 are disposed on the circuit board 303. The first millimeter-wave array antenna 102 includes a first feeding network 1021 connected to the first feeding point 101 and a first antenna array face 1022 fed by the first feeding network 1021. The second millimeter-wave array antenna 104 includes a second feeding network 1041 connected to the second feeding point 103 and a second antenna array face 1042 fed by the second feeding network 1041. The third millimeter-wave array antenna 106 includes a third feeding antenna 1061 connected to the third feeding point 105 and a third antenna array face fed by the third feeding network 1061. The fourth millimeter-wave array antenna 108 includes a fourth feeding network 1081 connected to the fourth feeding point 107 and a fourth antenna array face 1082 fed by the fourth feeding network 1081. Specific settings of the antenna system are as shown in FIG. 4 and FIG. 5.

The first antenna array face 1022 includes a plurality of first antenna units 1022a. The second antenna array face 1042 includes a plurality of second antenna units 1042a. The third antenna array face 1062 includes a plurality of third antenna units 1062a. The fourth antenna array face 1082 includes a plurality of fourth antenna units 1082a.

Particularly, the numbers of the first antenna units 1022a in the first antenna array face 1022, the second antenna units 1042a in the second antenna array face 1042, the third antenna units 1062a in the third antenna array face 1062 and the fourth antenna units 1082a in the fourth antenna array face 1082 may be the same or different. For example, the first antenna array face 1022 includes four first antenna units 1022a. The second antenna array face 1042 includes five second antenna units 1042a. The third antenna array face 1062 includes six third antenna units 1062a. The fourth antenna array face 1082 includes seven fourth antenna units 1082a.

In this embodiment, the numbers of the first antenna units 1022a, the second antenna units 1042a, the third antenna units 1062a and the fourth antenna units 1082a are the same and are particularly eight.

In this embodiment, the first feeding network 1021 includes a plurality of first phase shifters 1021a of which the number is the same as that of the first antenna units 1022a. Each first antenna unit 1022a is electrically connected with the first feeding point 101 through one of the first phase shifters 1021a. The second feeding network 1041 includes a plurality of second phase shifters 1041a of which the number is the same as that of the second antenna units 1042a. Each second antenna unit 1042a is electrically connected with the second feeding point 103 through one of the second phase shifters 1041a. The third feeding network 1061 includes a plurality of third phase shifters 1061a of which the number is the same as that of the third antenna units 1062a. Each third antenna unit 1062a is electrically connected with the third feeding point 105 through one of the third phase shifters 1061a. The fourth feeding network 1081 includes a plurality of fourth phase shifters 1081a of which the number is the same as that of the fourth antenna units 1082a. Each fourth antenna unit 1082a is electrically connected with the fourth feeding point 107 through one of the fourth phase shifters 1081a. A specific connection structure is as shown in FIG. 4 and FIG. 5.

In this embodiment, the phase shifters are 5-bit. Each phase shifter has the phase shift accuracy of 11.25 degrees. Certainly, the phase shift accuracy and the number of bits of the phase shifters may be determined according to actual situations, and either of the two is not limited.

It should be noted that in this embodiment, each radiation unit is equipped with one phase shifter. But in other embodiments, multiple antenna units may share the same phase shifter.

In this embodiment, each of the antenna array faces is in a form of a one-dimensional linear array. The first antenna units 1022a and the second antenna units 1042a are respectively arranged into a one-dimensional linear array at intervals along a Y-axis direction. The third antenna units 1062a and the fourth antenna units 1082a are respectively arranged into a one-dimensional linear array at intervals along an X-axis direction. As shown in FIG. 2A, FIG. 2B, FIG. 4 and FIG. 5, the first antenna array face 1022 and the second antenna array face 1042 are disposed at two opposite sides in a Z-axis direction, the first antenna array face 1022 faces the positive axis of the Z axis, and the second antenna array face 1042 faces a negative axis of the Z axis; and the third antenna array face 1062 and the fourth antenna array face 1082 are disposed at two opposite sides of the Y-axis direction respectively, the third antenna array face 1062 faces a positive axis of the Y axis, and the fourth antenna array face 1082 faces a negative axis of the Y axis.

According to the antenna system provided by this embodiment, beam scanning of antenna arrays may be controlled by the phase shifters. As the antenna arrays adopt the one-dimensional linear arrays, the phase shifters in each millimeter-wave array antenna only need to scan one angle. Thus, the scanning difficulty of the millimeter-wave array antennas is simplified.

It should be noted that the arrangement forms of the antenna units or the disposing positions of the antenna array faces are not limited to the embodiment. In other embodiments, a planar array may be adopted, and the antenna array faces may be disposed in other positions. For example, an end-fire array serves as a millimeter-wave array antenna, if beams of the millimeter-wave array antenna are required to point to a positive-axis direction of the Y axis, the antenna units thereof may be arranged along the Y axis but not in the X-axis direction as the third antenna array face of the third millimeter-wave array antenna in this embodiment.

In addition, the antenna array faces may be disposed on the circuit board or a support, may be disposed on a housing through press-fitting, LDS, or the like, and may also be metal housings per se. The specific embodiments are determined according to actual situations of the mobile terminal and will not be limited in the present disclosure. For example, the first antenna array face 1022 may be directly disposed on the surface, facing the screen 301, of the circuit board 303 and may also be disposed on a front shell of the mobile terminal. The front shell is parallel and opposite to the screen. The second antenna array face 1042 may be directly disposed on the circuit board 303 and may also be disposed on the back shell 302. The third antenna array face 1062 and the fourth antenna array face 1082 may be disposed on the support on a side surface of the circuit board 303, and may be formed by metal frames per se.

In this embodiment, the first antenna array face 1022, the second antenna array face 1042, the third antenna array face 1062 and the fourth antenna array face 1082 are closer to the top than the bottom of the mobile terminal. This because that a side edge close to the bottom of the mobile terminal is always a hand-held portion of a user. The top of the mobile terminal is less influenced by the user, which facilitates signal propagation.

In addition, the four millimeter-wave array antennas in the present disclosure are placed very close to a main board or a small board, such that line loss from RFFE to the antenna units may be reduced.

In the following, the operating principle and the operating effect of the antenna system 10 will be described in detail by taking a smart phone as an example.

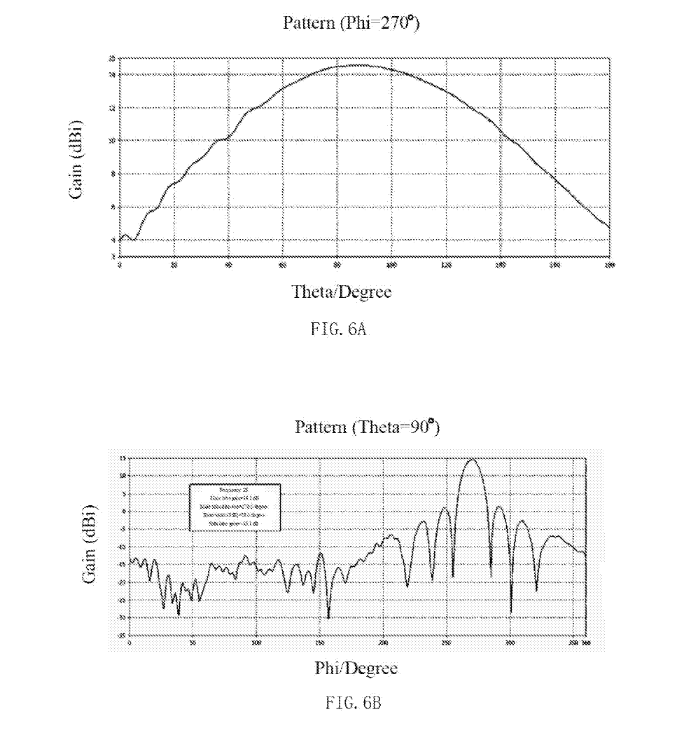

By taking the fourth millimeter-wave array antenna 108 as an example, as shown in FIG. 3C, the beams of the fourth millimeter-wave array antenna 108 point to the space of Y<0. As shown in FIG. 6A and FIG. 6B, the fourth millimeter-wave array antenna 108 operates at 28 GHz. The main beam of the fourth millimeter-wave array antenna 108 points to a Phi=270 ° Mirection, namely the negative-axis direction of the Y axis, when the fourth antenna units 1062a are fed at a constant amplitude and a same phase . The main beam of the fourth millimeter-wave array antenna 108 has a wide beam in a pitch plane)(Phi=270°) and has a relatively narrower beam in an azimuth plane)(Theta=90°). A 3 dB beam has the width of 13 degrees (deg). A main lobe has the maximum gain of 14.5 dB. A minor lobe has the gain of −13.1 dB.

As the fourth phase shifters 1081a control the phases positions of the fourth antenna units 1082a, the fourth millimeter-wave array antenna 108 performs beam scanning in a Y<0 semi-space along an azimuth angle to make up for the deficiency of relatively narrower beams in the azimuth plane.

Similarly, the third millimeter-wave array antenna 106 also has wide beams in a pitch plane and can realize beam scanning in the space of Y>0.

It can be seen that the third millimeter-wave array antenna 106 has relatively stronger beam coverage in the space of Y>0, the fourth third millimeter-wave array antenna 108 has relatively stronger beam coverage in the space of Y<0, and the third millimeter-wave array antenna 106 and the fourth millimeter-wave array antenna 108 have complementary beam coverage. Thus, the radiation capabilities of originally weak radiation areas are enhanced.

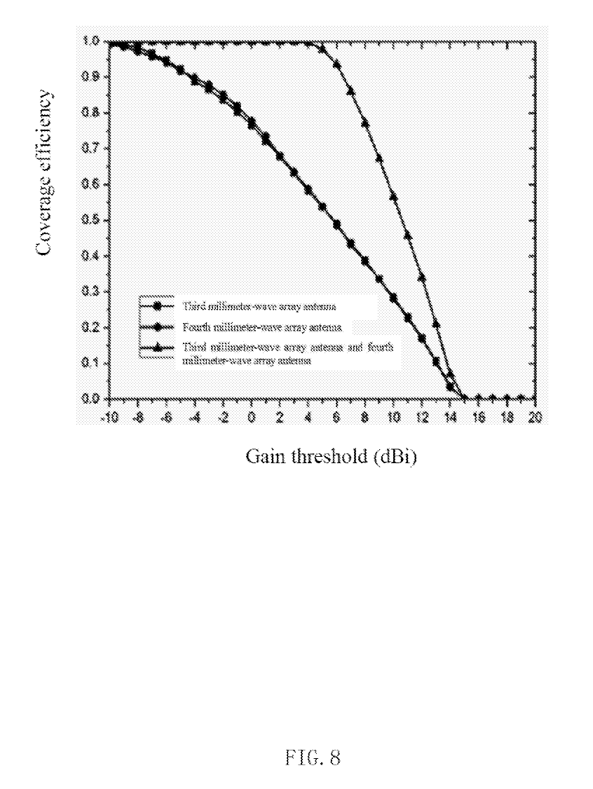

The beam coverage efficiency when the third millimeter-wave array antenna 106 and the fourth millimeter-wave array antenna 108 operate independently or simultaneously is as shown in FIG. 8. It can be seen from FIG. 8 that the beam coverage efficiency when the third millimeter-wave array antenna 106 and the fourth millimeter-wave array antenna 108 operate simultaneously is much higher than that when they operate independently. The third millimeter-wave array antenna 106 and the fourth millimeter-wave array antenna 108 are used together to improve the beam coverage efficiency of the antenna system.

Similarly, the main beam of the first millimeter-wave array antenna 102 points to the positive axis of the Z axis when the first antenna units 1022a are fed at a constant amplitude and a same phase , and has a wide beam in an XOZ plane and a relatively narrower beam in a YOZ plane. Through control by the phase shifters, the first millimeter-wave array antenna 102 realizes scanning along the YOZ plane. The second millimeter-wave array antenna 104 and the first millimeter-wave array antenna 102 are similar, but have different radiation directions. It can be seen that the first millimeter-wave array antenna 102 has relatively stronger beam coverage in the space of Z>0, the second millimeter-wave array antenna 104 has relatively stronger beam coverage in the space of Z<0, and the first millimeter-wave array antenna 102 and the second millimeter-wave array antenna 104 have complementary beam coverage. Thus, the radiation capabilities of originally weak radiation areas are enhanced.

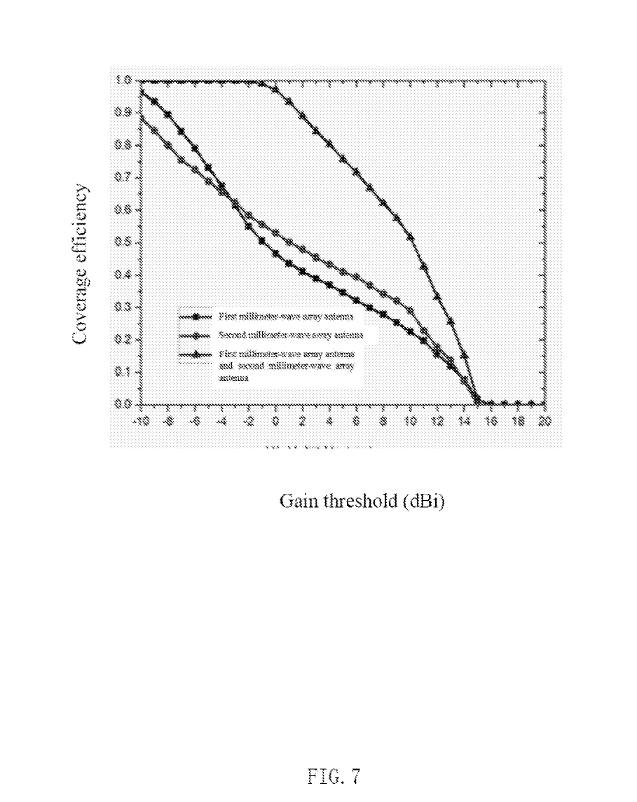

The beam coverage efficiency when the first millimeter-wave array antenna 102 and the second millimeter-wave array antenna 104 operate independently or simultaneously is as shown in FIG. 7. It can be seen from FIG. 7 that the beam coverage efficiency when the first millimeter-wave array antenna 102 and the second millimeter-wave array antenna 104 operate simultaneously is much higher than that when they operate independently.

It is worth mentioning that although the third millimeter-wave array antenna 106 and the fourth millimeter-wave array antenna 108 have wide beams in the pitch planes, the gain of beams in the positive-axis direction and the negative-axis direction of the Z axis and peripheral areas thereof is small. That is, a signal is relatively weaker. The maximum beam of the first millimeter-wave array antenna 102 exactly points to the positive-axis direction of the Z axis. The maximum beam of the second millimeter-wave array antenna 104 exactly points to the negative-axis direction of the Z axis. Thus, the coverage efficiency of the antenna system will be further improved when a combination of the first millimeter-wave array antenna 102 and the second millimeter-wave array antenna 104 and a combination of the third millimeter-wave array antenna 106 and the fourth millimeter-wave array antenna 108 operate simultaneously.

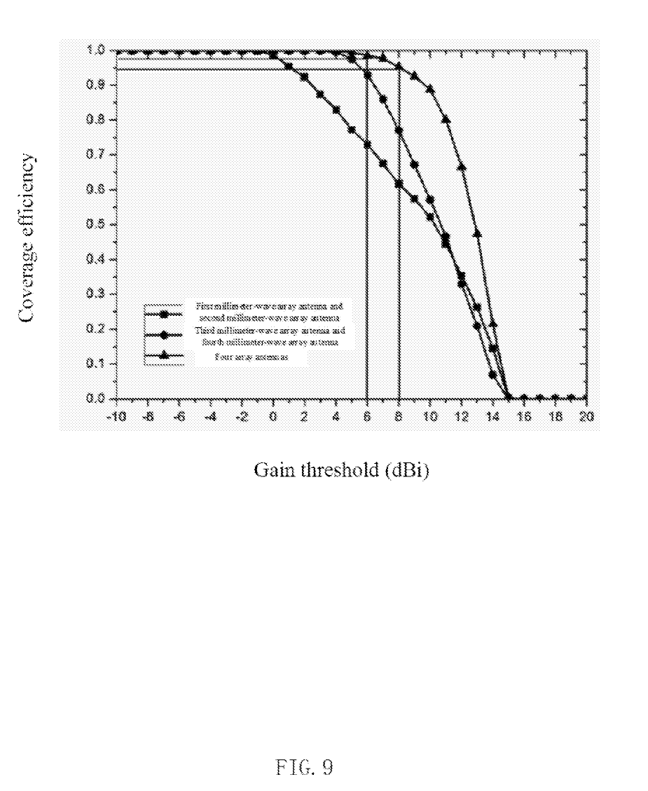

FIG. 9 is a beam coverage efficiency view when the combination of the first millimeter-wave array antenna 102 and the second millimeter-wave array antenna 104 and the combination of the third millimeter-wave array antenna 106 and the fourth millimeter-wave array antenna 108 operate independently or simultaneously. It can be seen from FIG. 9 that the beam coverage efficiency when the four array antennas operate simultaneously is much higher than that when the two antenna combinations operate independently. Thus, in this embodiment, the antenna system can be increased in beam coverage and improved in beam coverage efficiency.

Compared with the related art, the embodiment of the present disclosure has the advantages that as the beams of the first millimeter-wave array antenna cover the space of Z>0 and the beams of the second millimeter-wave array antenna cover the space of Z<0, beam ranges of the first millimeter-wave array antenna and the second millimeter-wave array antenna may be combined to cover the whole space; and meanwhile, as the beams of the third millimeter-wave array antenna cover the space of Y>0 and the beams of the fourth millimeter-wave array antenna cover the space of Y<0, beam ranges of the third millimeter-wave array antenna and the fourth millimeter-wave array antenna may be combined to cover the whole space. The four millimeter-wave array antennas are combined to further improve the coverage efficiency of the antenna system. Even if relatively stronger beam radiation exists in all directions of the space, the signal receiving stability of the antenna system is guaranteed.

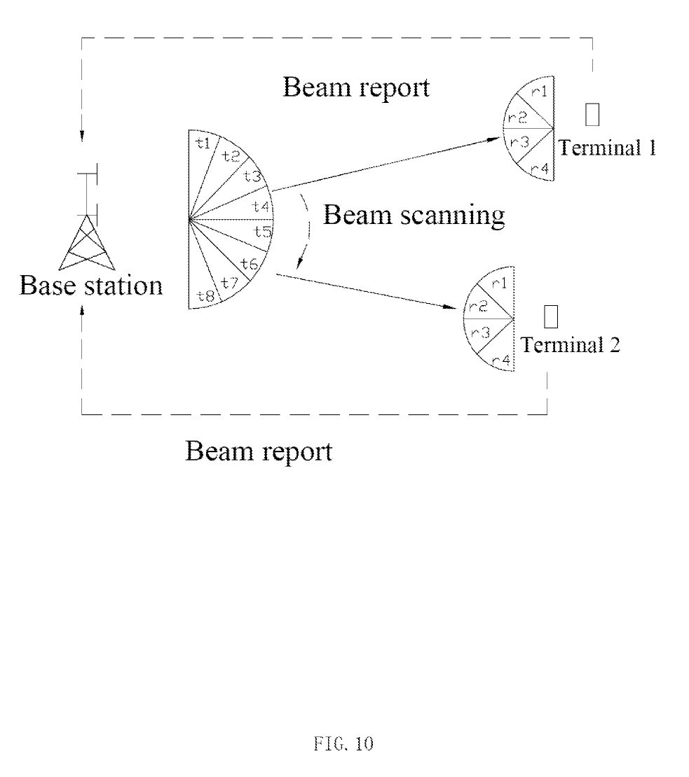

Besides, in this embodiment, the base station and the mobile terminal realize communication connection through the beam-forming technology of which the core technology is beam management. An objective of beam management is to align beams of the base station with beams of a terminal so as to maximize a receiving gain and a transmitting gain in a link. The principle of beam management is as shown in FIG. 10: the base station sequentially adopts different beams (as shown in tl-t8 of FIG. 10) to transmit wireless signals (beam scanning); the terminal switches the beams (as shown in r1-r4 of FIG. 10) to receive the wireless signals and reports relevant information (beam report) to the base station; and the terminal determines preferred beams that receive the wireless signals in accordance with the received maximum wireless signal (beam test).

In this embodiment, the following beam management method may be adopted. The base station sequentially adopts different beams to transmit the wireless signals. The terminal switches the beams to receive the wireless signals and determines a gain of a main lobe, facing the base station, of a first group antenna array 101 as a first gain, a gain of a main lobe, facing the base station, of a second group antenna array 102 as a second gain, a gain of a main lobe, facing the base station, of a third group antenna array 103 as a third gain and a gain of a main lobe, facing the base station, of a fourth group antenna array 104 as a fourth gain. The first largest gain and the second largest gain are selected from the four antenna gains. The antenna arrays that correspond to the first largest gain and the antenna arrays that correspond to the second largest gain serve as the antenna arrays for signal transmission. Thus, multiple input multiple output (MIMO) or diversity of the antennas is realized. The signal transmission accuracy and stability of the antenna system are further ensured. Certainly, in other embodiments, other beam management methods may be adopted. Here, only an example is taken for explanation. No matter which beam management method is adopted, the layout of the antenna system in the embodiment is not affected.

A second embodiment of the present disclosure relates to a mobile terminal 30 that includes an antenna system 10.

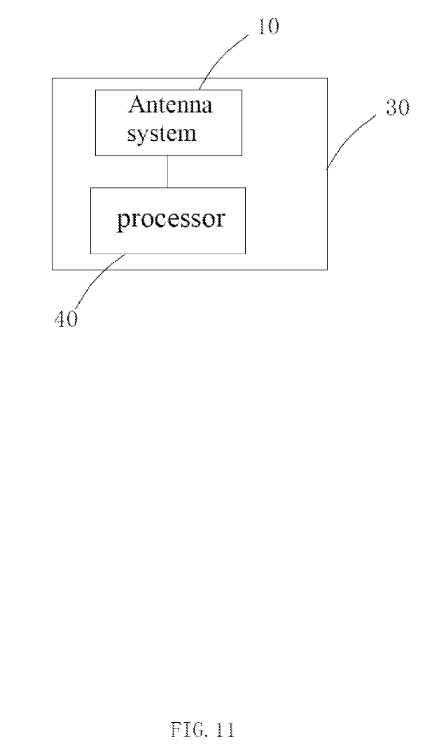

Preferably, the mobile terminal 30 further includes a processor 40. The structure of the mobile terminal is as shown in FIG. 11. The processor 40 is particularly configured to: determine a gain of a main lobe, facing the base station, of a first millimeter-wave array antenna as a first gain, a gain of a main lobe, facing the base station, of a second millimeter-wave array antenna as a second gain, a gain of a main lobe, facing the base station, of a third millimeter-wave array antenna as a third gain and a gain of a main lobe, facing the base station, of a fourth millimeter-wave array antenna as a fourth gain; and select two gains from the first gain, the second gain, the third gain and the fourth gain in a descending order and use antenna arrays that correspond to the selected two gains for signal transmission.

Particularly, the base station sequentially uses different beams to transmit wireless signals. The processor switches the beams to receive the wireless signals and determines the gain of a main lobe, facing the base station, of the first millimeter-wave array antenna as the first gain, the gain of a main lobe, facing the base station, of the second millimeter-wave array antenna as the second gain, the gain of a main lobe, facing the base station, of the third millimeter-wave array antenna as the third gain and the gain of a main lobe, facing the base station, of the fourth millimeter-wave array antenna as the fourth gain. The processor 40 selects the first largest gain and the second largest gain from the four gains, uses the array antenna corresponding to the first largest gain and the array antenna corresponding to the second largest gain as the array antennas for signal transmission, thereby realizing MIMO or diversity of the antennas and further ensuring the signal transmission accuracy and stability of the antenna system. For example, assuming that the first gain is A(dB), the second gain is B(dB), the third gain is C(dB) and the fourth gain is D(dB), and A<B<C<D, the first gain is determined as the first largest gain, the second gain is determined as the second largest gain, and the first millimeter-wave array antenna and the second millimeter-wave array antenna are used for signal transmission.

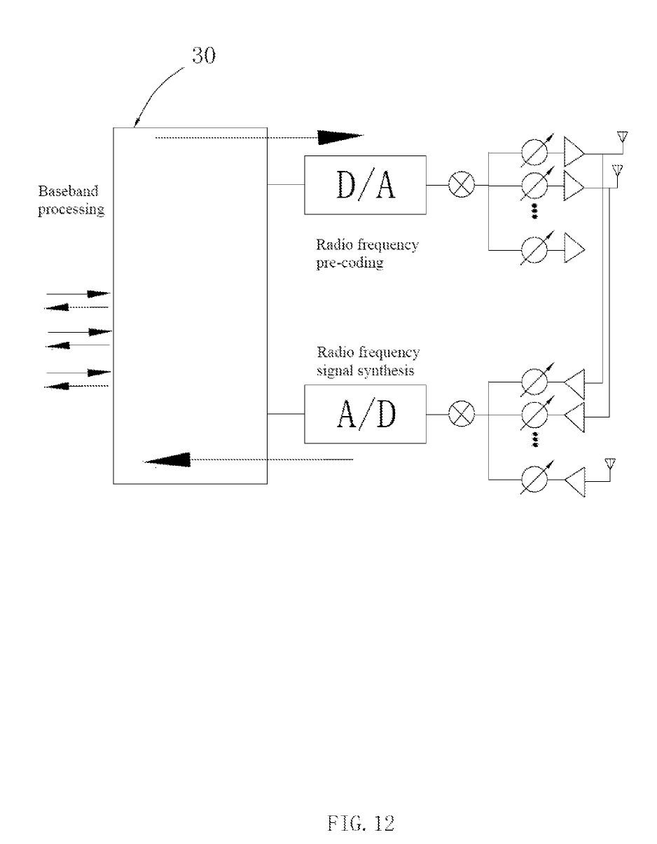

It is worth mentioning that the antenna system in the terminal adopts a phased array structure as shown in FIG. 12.

According to the mobile terminal provided by the embodiment, the processor determines the two millimeter-wave array antennas for signal transmission through beam management, such that the whole radiation covered field intensity is more balanced, and weak edge radiation under a single combination is avoided. Meanwhile, the two millimeter-wave array antennas are employed to realize the MIMO or diversity of the antennas. Thus, the signal receiving capability of the terminal is enhanced.

It should be understood by those skilled in the art that, all or part of the steps of the methods in the above embodiments may be implemented through programs that give instructions to respective hardware. The programs may be stored in a storage medium and include several instructions to cause a device (a single chip microcomputer, a chip, or the like) or the processor to execute all or part of the steps of the methods of the embodiments of the present disclosure. The foregoing storage medium includes a USB disk, a mobile hard disk, a read-only memory (ROM), a random access memory (RAM), a magnetic disk or an optical disk which may store program codes.

Those of ordinary skill in the art may understand that the above embodiments are specific embodiments for implementing the present disclosure. In application, various changes may be made in form and detail without departing from the spirit or the scope of the present disclosure.

What is claimed is:

1. An antenna system, applied to a mobile terminal which is provided with a screen, a back shell opposite to the screen and a circuit board sandwiched between the screen and the back shell, the antenna system including:
a first feeding point;
a first millimeter-wave array antenna electrically connected to the first feeding point;
a second feeding point;
a second millimeter-wave array antenna electrically connected to the second feeding point;
a third feeding point;
a third millimeter-wave array antenna electrically connected to the third feeding point;
a fourth feeding point; and
a fourth millimeter-wave array antenna electrically connected to the fourth feeding point, which are all disposed on the circuit board,
wherein when the mobile terminal is placed in a three-dimensional coordinate system that takes a center of the mobile terminal as an origin, an X axis of the three-dimensional coordinate system extends in a major-axis direction of the mobile terminal, a Y axis of the three-dimensional coordinate system extends in a minor-axis direction of the mobile terminal, a Z axis of the three-dimensional coordinate system extends in a thickness direction of the mobile terminal, a positive axis of the X axis points to the top of the mobile terminal, and a positive axis of the Z axis points to the screen,
beams of the first millimeter-wave array antenna cover a space of Z>0;
beams of the second millimeter-wave array antenna cover a space of Z<0;
beams of the third millimeter-wave array antenna cover a space of Y>0; and
beams of the fourth millimeter-wave array antenna cover a space of Y<0.

2. The antenna system according to claim 1, wherein
the first millimeter-wave array antenna implements beam scanning in the space of Z>0;
the second millimeter-wave array antenna implements beam scanning in the space of Z<0;
the third millimeter-wave array antenna implements beam scanning in the space of Y>0; and
the fourth millimeter-wave array antenna implements beam scanning in the space of Y<0.

3. The antenna system according to claim 2, wherein
the first millimeter-wave array antenna comprises a first feeding network connected to the first feeding point and a first antenna array face fed by the first feeding network;
the second millimeter-wave array antenna comprises a second feeding network connected to the second feeding point and a second antenna array face fed by the second feeding network;
the third millimeter-wave array antenna comprises a third feeding network connected to the third feeding point and a third antenna array face fed by the third feeding network; and
the fourth millimeter-wave array antenna comprises a fourth feeding network connected to the fourth feeding point and a fourth antenna array face fed by the fourth feeding network.

4. The antenna system according to claim 3, wherein
the first antenna array face and the second antenna array face are respectively disposed at two opposite sides in a Z-axis direction, the first antenna array face faces a positive axis of the Z axis, and the second antenna array face faces a negative axis of the Z axis; and
the third antenna array face and the fourth antenna array face are respectively disposed at two opposite sides in a Y-axis direction, the third antenna array face faces a positive axis of the Y axis, and the fourth antenna array face faces a negative axis of the Y axis.

5. The antenna system according to claim 4, wherein the first antenna array face, the second antenna array face, the third antenna array face and the fourth antenna array face are closer to a top than a bottom of the mobile terminal.

6. The antenna system according to claim 4, wherein the first antenna array face comprises a plurality of first antenna units, the second antenna array face comprises a plurality of second antenna units, the third antenna array face comprises a plurality of third antenna units, and the fourth antenna array face comprises a plurality of fourth antenna units.

7. The antenna system according to claim 6, wherein the plurality of first antenna units and the plurality of second antenna units are respectively arranged into a one-dimensional linear array at intervals along the Y-axis direction, and the plurality of third antenna units and the plurality of fourth antenna units are respectively arranged into a one-dimensional linear array at intervals in an X-axis direction.

8. The antenna system according to claim 7, wherein
the first feeding network comprises a plurality of first phase shifters, a number of the plurality of first phase shifters is the same as a number of the plurality of first antenna units, and each of the plurality of first antenna units is electrically connected to the first feeding point through one of the plurality of first phase shifters;
the second feeding network comprises a plurality of second phase shifters, a number of the plurality of second phase shifters is the same as a number of the plurality of second antenna units, and each of the plurality of second antenna units is electrically connected to the second feeding point through one of the plurality of second phase shifters;
the third feeding network comprises a plurality of third phase shifters, a number of the plurality of third phase shifters is the same as a number of the plurality of third antenna units, and each of the plurality of third antenna units is electrically connected to the third feeding point through one of the plurality of third phase shifters; and
the fourth feeding network comprises a plurality of fourth phase shifters, a number of the plurality of fourth phase shifters is the same as a number of the plurality of fourth antenna units, and each of the plurality of fourth antenna units is electrically connected to the fourth feeding point through one of the plurality of fourth phase shifters.

9. A mobile terminal, comprising the antenna system according to claim 1.

10. The mobile terminal according to claim 9, comprising a processor, wherein the processor is particularly configured to:
determine a gain of a main lobe, facing the base station, of a first millimeter-wave array antenna as a first gain, a gain of a main lobe, facing the base station, of a second millimeter-wave array antenna as a second gain, a gain of a main lobe, facing the base station, of a third millimeter-wave array antenna as a third gain, and a gain of a main lobe, facing the base station, of a fourth millimeter-wave array antenna as a fourth gain; and
select two gains from the first gain, the second gain, the third gain and the fourth gain in a descending order, and use the millimeter-wave array antennas corresponding to the selected two gains for signal transmission.

11. The antenna system according to claim 9, wherein
the first millimeter-wave array antenna implements beam scanning in the space of Z>0;
the second millimeter-wave array antenna implements beam scanning in the space of Z<0;
the third millimeter-wave array antenna implements beam scanning in the space of Y>0; and
the fourth millimeter-wave array antenna implements beam scanning in the space of Y<0.

12. The antenna system according to claim 11, wherein
the first millimeter-wave array antenna comprises a first feeding network connected to the first feeding point and a first antenna array face fed by the first feeding network;
the second millimeter-wave array antenna comprises a second feeding network connected to the second feeding point and a second antenna array face fed by the second feeding network;
the third millimeter-wave array antenna comprises a third feeding network connected to the third feeding point and a third antenna array face fed by the third feeding network; and
the fourth millimeter-wave array antenna comprises a fourth feeding network connected to the fourth feeding point and a fourth antenna array face fed by the fourth feeding network.

13. The antenna system according to claim 12, wherein
the first antenna array face and the second antenna array face are respectively disposed at two opposite sides in a Z-axis direction, the first antenna array face faces a positive axis of the Z axis, and the second antenna array face faces a negative axis of the Z axis; and
the third antenna array face and the fourth antenna array face are respectively disposed at two opposite sides in a Y-axis direction, the third antenna array face faces a positive axis of the Y axis, and the fourth antenna array face faces a negative axis of the Y axis.

14. The antenna system according to claim 13, wherein the first antenna array face, the second antenna array face, the third antenna array face and the fourth antenna array face are closer to a top than a bottom of the mobile terminal.

15. The antenna system according to claim 13, wherein the first antenna array face comprises a plurality of first antenna units, the second antenna array face comprises a plurality of second antenna units, the third antenna array face comprises a plurality of third antenna units, and the fourth antenna array face comprises a plurality of fourth antenna units.

16. The antenna system according to claim 15, wherein the plurality of first antenna units and the plurality of second antenna units are respectively arranged into a one-dimensional linear array at intervals along the Y-axis direction, and the plurality of third antenna units and the plurality of fourth antenna units are respectively arranged into a one-dimensional linear array at intervals in an X-axis direction.

17. The antenna system according to claim 16, wherein
the first feeding network comprises a plurality of first phase shifters, a number of the plurality of first phase shifters is the same as a number of the plurality of first antenna units, and each of the plurality of first antenna units is electrically connected to the first feeding point through one of the plurality of first phase shifters;
the second feeding network comprises a plurality of second phase shifters, a number of the plurality of second phase shifters is the same as a number of the plurality of second antenna units, and each of the plurality of second antenna units is electrically connected to the second feeding point through one of the plurality of second phase shifters;
the third feeding network comprises a plurality of third phase shifters, a number of the plurality of third phase shifters is the same as a number of the plurality of third antenna units, and each of the plurality of third antenna units is electrically connected to the third feeding point through one of the plurality of third phase shifters; and
the fourth feeding network comprises a plurality of fourth phase shifters, a number of the plurality of fourth phase shifters is the same as a number of the plurality of fourth antenna units, and each of the plurality of fourth antenna units is electrically connected to the fourth feeding point through one of the plurality of fourth phase shifters.
